(19) United States
(12) Patent Application Publication
(10) Pub. No.: US 2017/0312575 A1
(43) Pub. Date: Nov. 2, 2017

(54) REHABILITATION EXERCISE SYSTEM

(71) Applicant: SINGAPORE UNIVERSITY OF TECHNOLOGY AND DESIGN, Singapore (SG)

(72) Inventors: Suranga Chandima NANAYAKKARA, Singapore (SG); Nuwan Janaka NANAYAKKARAWASAM PERU KANDAGE, Singapore (SG); Roshan Lalintha PEIRIS, Singapore (SG); Anusha Indrajith WITHANAGE DON, Singapore (SG)

(73) Assignee: Singapore University of Technology and Design, Singapore (SG)

(21) Appl. No.: 15/520,861

(22) PCT Filed: Oct. 21, 2015
(86) PCT No.: PCT/SG2015/050405

§ 371 Date: Apr. 21, 2017

(30) Foreign Application Priority Data
Oct. 21, 2014 (SG) 10201406827S

(51) Int. Cl. A63B 24/00; G09B 5/02; A63B 21/00

(52) U.S. Cl. CPC A63B 24/0021; G09B 5/02; A63B 21/0004; A63B 24/0003; A63B 2024/0028

(57) ABSTRACT

According to various embodiments, a system may be provided. The system may include: a platform including a plurality of engaging members; a portable device configured to engage with the platform using at least one engaging member of the plurality of engaging members; and a feedback member configured to provide information indicating whether the portable device is engaged with the platform.

### CROSS-REFERENCE TO RELATED APPLICATIONS

The present application is a national stage entry according to 35 U.S.C. §371 of PCT application No.: PCT/SG2015/050405 filed on Oct. 21, 2015, which claims the benefit of the Singapore patent application No. 10201406827S filed on 21 Oct. 2014, the entire contents of which are incorporated herein by reference for all purposes.

### TECHNICAL FIELD

Embodiments relate generally to systems.

### BACKGROUND

Current provision for exercise in stroke rehabilitation is the use of a simple, wooden board, which notches cut from the edge of the frame at the sides, and a wooden pole, similar to a broom handle. The goal of the exercise is to place the pole into the notches in turn, ascending up the board. One of the common effects of a stroke may be to leave the patient weaker along one side of the body (hemiparesis). The shoulder may a particular problem area, as it is both a key and complex joint, due to the required movement and strength simultaneously required. As such, exercise and rehabilitation of the ‘weaker’ shoulder is considered a critical stage in stroke rehabilitation. The current methodology attempts to achieve this through the use of a two-handed exercise (holding the pole), thereby allowing the ‘stronger’ shoulder to guide and lead the ‘weaker’ shoulder, both for re-strengthening the muscles and to re-learn the co-ordination necessary.

However, this current, passive exercise relies heavily on medical observation and guidance, as the patient is unaware of the ‘proper’ actions, and errors learned at this stage can be more difficult to rectify later. This is made more difficult by the environment, whereby often a single physiotherapist will oversee numerous stroke patients, or rehabilitation will take place in the patient's home. Thus, there may be a need for enhanced devices.

### SUMMARY

According to various embodiments, a system may be provided. The system may include: a platform including a plurality of engaging members; a portable device configured to engage with the platform using at least one engaging member of the plurality of engaging members; and a feedback member configured to provide information indicating whether the portable device is engaged with the platform.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. In the following description, various embodiments are described with reference to the following drawings, in which:

FIG. 1 shows a system according to various embodiments;

FIG. 2 shows an illustration of a system according to various embodiments;

FIG. 3 shows an activity flow diagram for the platform according to various embodiments;

FIG. 4 shows an activity flow diagram for the portable device according to various embodiments;

FIG. 5 shows an illustration of the composite structure of the platform according to various embodiments;

FIG. 6 shows an illustration of the composite structure of the portable device according to various embodiments;

FIG. 7 shows an illustration of the composite structure of the software provision according to various embodiments;

FIG. 8 shows an illustration of responsive objects according to various embodiments;

FIG. 9 shows an illustration of game feedback according to various embodiments;

FIG. 10A shows an illustration of reading the score on the personalized pole according to various embodiments;

FIG. 10B shows an illustration of placing the pole on the platform for identification according to various embodiments;

FIG. 11 shows an illustration of the pole contents according to various embodiments;

FIG. 12 shows an illustration of platform contents and features according to various embodiments;

FIG. 13 shows an illustration of an interaction scenario according to various embodiments;

FIG. 14 shows an illustration of various states of the platform according to various embodiments; and

FIG. 15A to FIG. 15R show screenshots according to various embodiments.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

In this context, the system as described in this description may include a memory which is for example used in the processing carried out in the system. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

Current provision for exercise in stroke rehabilitation is the use of a simple, wooden board, which notches cut from the edge of the frame at the sides, and a wooden pole, similar to a broom handle. The goal of the exercise is to place the pole into the notches in turn, ascending up the board. One of the common effects of a stroke may be to leave the patient weaker along one side of the body (hemiparesis). The shoulder may a particular problem area, as it is both a key and complex joint, due to the required movement and strength simultaneously required. As such, exercise and rehabilitation of the ‘weaker’ shoulder is considered a critical stage in stroke rehabilitation. The current methodology attempts to achieve this through the use of a two-handed exercise (holding the pole), thereby allowing the ‘stronger’ shoulder to guide and lead the ‘weaker’ shoulder, both for re-strengthening the muscles and to re-learn the co-ordination necessary.

In other words, exercise programs focusing on the rehabilitation of the shoulder are a common occurrence in post-stroke rehabilitation as the shoulder can significantly improve the ability to perform activities of daily living. These programs, commonly feature exercises that utilize both shoulders together such that the ‘strong’ shoulder is able to guide the ‘weak’ shoulder through the proper movements. One such activity involves the placing of a wooden pole into a pair of horizontal hooks. Multiple pairs of these hooks are fixed at various heights to a simple backboard (exercise ladder), requiring a patient to stretch both arms, and therefore both shoulders incrementally. Additionally, the patient is required keep the pole horizontal throughout this activity, ensuring that the weak shoulder is worked and guided by the strong shoulder. This rehabilitation program may be carried out in a one-to-one session, within a group session, or away from medical supervision in a home environment.

However, this current, passive exercise relies heavily on medical observation and guidance, as the patient is unaware of the ‘proper’ actions, and errors learned at this stage can be more difficult to rectify later. This is made more difficult by the environment, whereby often a single physiotherapist will oversee numerous stroke patients, or rehabilitation will take place in the patient's home.

In other words, while the exercise is in fact effective, our observations at the rehabilitation ward of a local hospital revealed some key major limitations faced by the patients, therapists and the doctors. Firstly, the lack of feedback from the exercise devices requires therapists to constantly keep an eye on the patients. This is a key limitation during a group rehabilitation session as there are only a few therapists overlooking the process. In addition, this often results in the patient repeating erroneous actions until noticed by a therapist. Secondly, the lack of recording and storing the specific activity information such as hand movements patterns, speed, etc. limits the doctors/therapists to look at the patient's rehabilitation history in finer detail in order to customize the exercise programs. Furthermore, it is almost impossible to review the patient's rehabilitation process when they performed them at home. These limitations could often reduce the effectiveness of the rehabilitation programs and even demotivate patients.

According to various embodiments, enhanced devices may be provided.

According to various embodiments, to address the above limitations, SHRUG—(Stroke Haptic Rehabilitation Using Gaming) like will be described below may be provided. SHRUG may examine the use of interactive technology principles to enhance the rehabilitation experience for both the patients and the therapists. According to various embodiments, the effectiveness of rehabilitation process for the therapists may be enhanced by converting the existing shoulder rehabilitation exercise platform into an interactive object that monitors, records and provides timely alerts. According to various embodiments, the experience of the rehabilitation process for the patients may be enhanced by providing immediate feedback of their actions and introducing motivational ‘gamified’ shoulder rehabilitation exercises. According to various embodiments, an interactive shoulder rehabilitation platform may be provided which responds and guides the patient through the exercise program.

According to various embodiments, devices may provide more information to both the medical team and patient in terms of the patients' specific performance and their rehabilitation progress, and may make the activity more stimulating, and thereby may increase motivation to continue and improve on the patients performance.

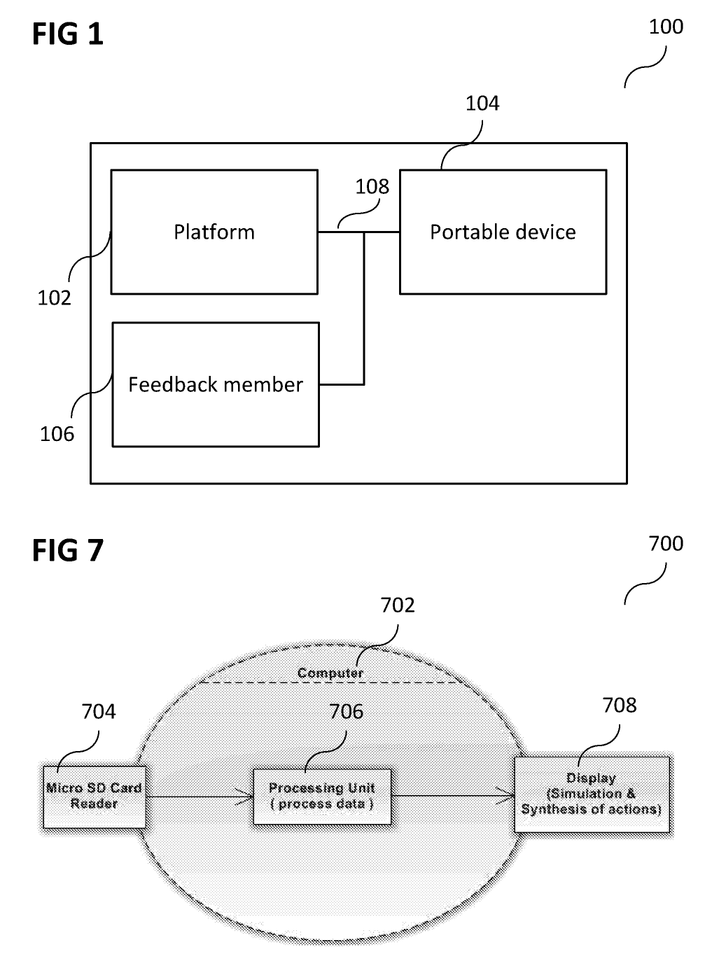

FIG. 1 shows a system 100 according to various embodiments. The system 100 may include a platform 102. The platform 102 may include a plurality of engaging members. The system 100 may further include a portable device 104 configured to engage with the platform 102 using at least one engaging member of the plurality of engaging members. The system 100 may further include a feedback member 106 (for example a feedback circuit) configured to provide information indicating whether the portable device 104 is engaged with the platform 102. The platform 102, the portable device 104, and the feedback member 106 may be coupled with each other, like indicated by lines 108, for example mechanically coupled or electrically coupled, for example connected via a wire or line, or wirelessly connected.

In other words, a system may include a portable device which may be placed on a platform, and the system may provide feedback based on how the portable device is placed on the platform.

According to various embodiments, the platform 102 may include a display (in other words: a visual apparatus). The display may be configured to provide visual feedback on the exercise carried out using the system 100. For example the display may indicate a result of how often (as a total number or as a portion of tries) the portable device 104 has been successfully engaged with the platform 102 at the target location. According to various embodiments, the display may be integrated (in other words: integrally provided) in the system, for example integrated on the platform 102 or integrated on the portable device 104. According to various embodiments, the display may be a display of a tablet device or smartphone (in other words, a tablet device or smartphone may be mounted on the platform 102 or the portable device 104, or the platform 102 or the portable device 104 may provide an interface to a tablet device or smartphone).

According to various embodiments, the platform 102 may include an indication member configured to indicate a target location.

According to various embodiments, the feedback member 106 may be configured to provide information indicating whether the portable device 104 is engaged with the platform 102 at the target location.

According to various embodiments, the indication member may include or may be a light source.

According to various embodiments, the light source may include or may be a light emitting diode.

According to various embodiments, a plurality of indication members may be provided, one indication member in proximity to each engaging member.

According to various embodiments, the portable device 104 may include or may be or may be included in a pole.

According to various embodiments, the portable device 104 may include a plurality of light sources.

According to various embodiments, the light sources may include or may be light emitting diodes.

According to various embodiments, the portable device 104 may include an orientation sensor.

According to various embodiments, the orientation sensor may include an accelerometer.

According to various embodiments, the system 100 further include a velocity determination circuit (for example in the platform 102 or in the portable device 104), configured to determine a velocity based on an output of the accelerometer.

According to various embodiments, the orientation sensor may include or may be or may be included in a magnetometer.

According to various embodiments, the orientation sensor may include or may be or may be included in a gyroscope.

According to various embodiments, the orientation sensor may include or may be or may be included in an inertial measurement unit.

According to various embodiments, the inertial measurement unit may include or may be or may be included in a 3 axis accelerometer, a 3 axis gyro and/or a 3 axis magnetometer.

According to various embodiments, the portable device 104 may include an orientation indication member.

According to various embodiments, the orientation indication member may be configured to indicate whether portable device 104 is in a horizontal orientation.

According to various embodiments, the portable device 104 may include a plurality of light sources, and the orientation indication member may include or may be the plurality of light sources.

According to various embodiments, each engaging member of the at least one engaging member may include or may be or may be included in at least one hook.

According to various embodiments, each engaging member of the at least one engaging member may include or may be or may be included in a pair of hooks provided at least substantially parallel near outer portions of the platform 102.

According to various embodiments, the platform 102 may include an indication member configured to indicate a target location, and the indication member may be provided in the hooks.

According to various embodiments, the feedback member 106 may be provided at the platform 102.

According to various embodiments, the feedback member 106 may be provided at the portable device 104.

According to various embodiments, the portable device 104 may include a success indication member configured to indicate a success rate of engaging the feedback member 106 with the platform 102.

According to various embodiments, the system 100 may further include a detection member (for example in the platform 102 or in the portable device 104), configured to determine whether the portable device 104 is engaged with the platform 102.

According to various embodiments, the detection member may include or may be a switch.

According to various embodiments, the detection member may include or may be an infrared proximity sensor.

According to various embodiments, the system 100 may further include a therapist console (not shown in FIG. 1) configured to receive data indicating a performance of a user of the system 100.

According to various embodiments, the system 100 may further include an alert device (not shown in FIG. 1) configured to provide an alert signal to a supervisor of a user of the system 100.

According to various embodiments, the platform 102 may include a radio frequency identification (RFID) tag configured to identify a user of the system 100.

According to various embodiments, the portable device 104 may include a radio frequency identification (RFID) tag configured to identify itself to the platform 102.

According to various embodiments, SHRUG, which is an interactive shoulder rehabilitation exerciser, may be provided. SHRUG may enhance the effectiveness of providing interactive and just-in-time feedback to the patients and therapists and may add a gaming element on the motivation of the patients.

Various embodiments may be used in the medical domain, for example in rehabilitation (for example stroke rehabilitation or physical rehabilitation), stroke therapy, and physical therapy, for example shoulder exercise.

Various embodiments consist of two elements. The first element is a rehabilitation board, with a number of pairs of hooks in the sides (for example four pairs, or for example six pairs). In addition, there are LEDs embedded into the board, one allocated for each hook, and a button on the side used to select the game mode. The second element is portable device (for example a pole, which may also be referred to as pole interface), for example approximately 1 m in length, with two strips of (for example 20) LEDs along the length, at opposite sides of the pole. The pole is paired to the board initially to create a communication. The board then illuminates two lights corresponding to a specific hook pair (depending on the specific task and game mode, these hook pairs are selected in a variety of ways), and the user may place the pole into the indicated hook pair. The pole detects its orientation along the horizontal axis, and displays the disparity between the lower and raised ends of the pole (disparity in shoulder harmony) along the LED strip on its length. The greater the disparity (for example the more the angle that the pole is being held at) the more of the LEDs are illuminated. When the pole is placed into the hook pairs, the indication LEDs on the board change color (for example from blue to green). If the pole is placed in an incorrect hook pair, or two hooks not in a pair, or the user takes too long to perform the task, the LEDs change color (for example to red). The device board and pole interface may communicate via RF (radio frequency; in other words: radio waves) to exchange data. The user's performance is scored by both the device board and the pole interface. Turning the pole 90 degrees so that it is in a vertical orientation displays the user's current score, as a percentage along the length of the pole.

Various embodiments may be used in the physical rehabilitation of stroke patients. Devices according to various embodiments (which may be referred to as SHRUG devices) may be an extension and ‘next step’ in the rehabilitation of stroke patients. They provide data and feedback to both the patient and the medical professionals. The data captured by the device may be further analyzed and compiled to give medical therapists a better picture of the performance of the patient, even remotely, for example where the patient is conducting the rehabilitation at home. A purpose of the rehabilitation exercise may be for the patient to perform the actions using both shoulders. A stroke often leaves a patient with reduced mobility along one side of their body, and the exercise with devices according to various embodiments may be used to promote proper actions, for the ‘strong’ shoulder to guide the ‘weak’ shoulder, and to strengthen and co-ordinate the muscles and movements.

Devices according to various embodiments may provide a guidance for the physical rehabilitation of stroke patients through its physical design, and may provide feedback and guidance on proper rehabilitation and motivation to continue this exercise through the electronics and design.

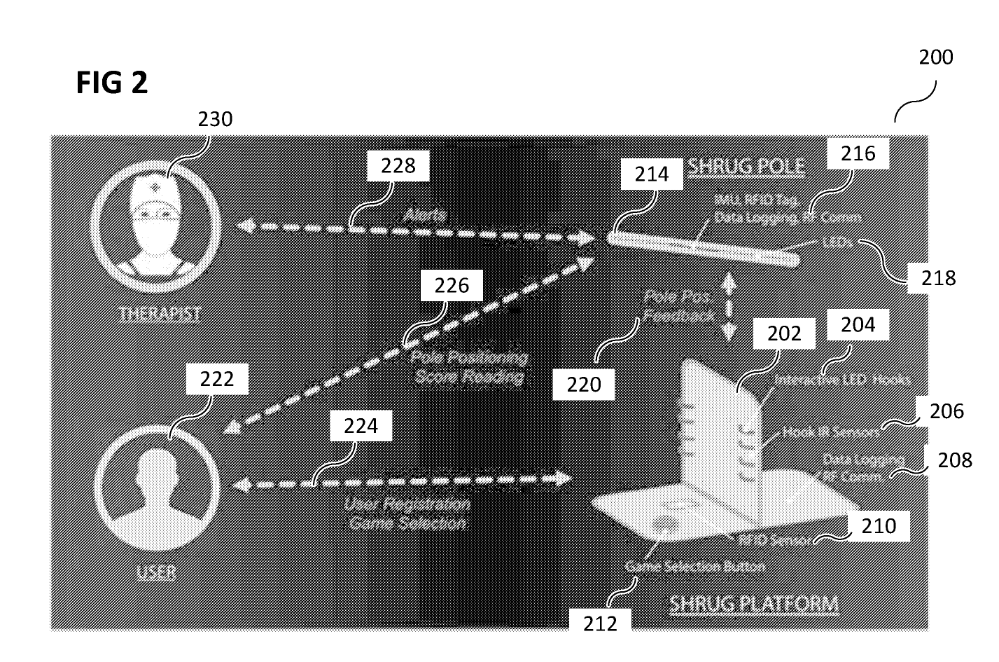

According to various embodiments, the SHRUG system may embed various sensors and actuators to provide interactive experiences to the users. The overall system is illustrated in FIG. 2. The SHRUG system may include a SHRUG Pole and a SHRUG platform.

FIG. 2 shows an illustration 200 of a system according to various embodiments (which may for example be referred to as SHRUG System). The system may include several physical elements. The system may include a rehabilitation exercise board 202 (which may also be referred to as SHRUG platform), for example with a backboard (for example a wooden backboard), and with hooks 204 (for example acrylic hooks) attached to the sides of the board. In addition, there are contact switches—one for each hook—and a series of multi-colored LEDs—also one for each hook. The hooks 204 may be attached in pairs (for example four pairs or for example to six pairs). A microprocessor may be provided on the device (in other words: the SHRUG platform), and a select button 212. The hooks 204 may be provided with sensors, for example IR (infrared sensors 206). Data logging and RF communication may be provided, like illustrated by 208. An RFID (radio frequency identification) sensor 210 may be provided on the SHRUG platform 202.

The system may further include a portable device (for example a pole interface 214). The pole interface 214 may for example be a plastic tube, for example approximately 1 m in length. It may have two strips of LEDs (light emitting diodes 218), for example two strips of 20 LEDS, for example on opposite sides around the circumference of the pole, for example running along the length of the pole. Internally, the pole 214 may contains an IMU 216 (for example configured to detect 6 DoF (degrees of freedom), for example: x-axis, y-axis, z-axis, pan, tilt and roll) and a processor. The composite structure diagrams for the device and pole may be like described in more detail below. The device backboard may utilize the Arduino open source platform, released under the GNU public license, and the GNU lesser general public license. The pole interface may utilize the Teensy 3 microprocessor, which is also distributed under the GNU general public license.

The platform 202 and the portable device 214 may communicate with each other, like illustrated by 220. A user 222 may register with the platform 202 and may select a game, like illustrated by 224. By positioning the portable device 214 in a pre-determined orientation (for example vertically, like described in more detail below), the user 222 may read his score, like illustrated by 226. A therapist 230 may receive alerts from the system, like illustrated by 228.

In the following, interactions with SHRUG will be described.

The SHRUG platform, when in operation, may allocate a hook pair and may signify this to the user by illuminating the corresponding LEDs, for example in blue. The patient is then required to place the pole in the selected hook pair within a time limit. On successful completion of this, the LEDs change color, for example to green. If the patient takes too long for this, or places the pole in the wrong hook pair, or places the pole in two hooks at different levels (not in the same pair) the LEDs instead change color to another color, for example to red, and the next hook pair is identified by the board.

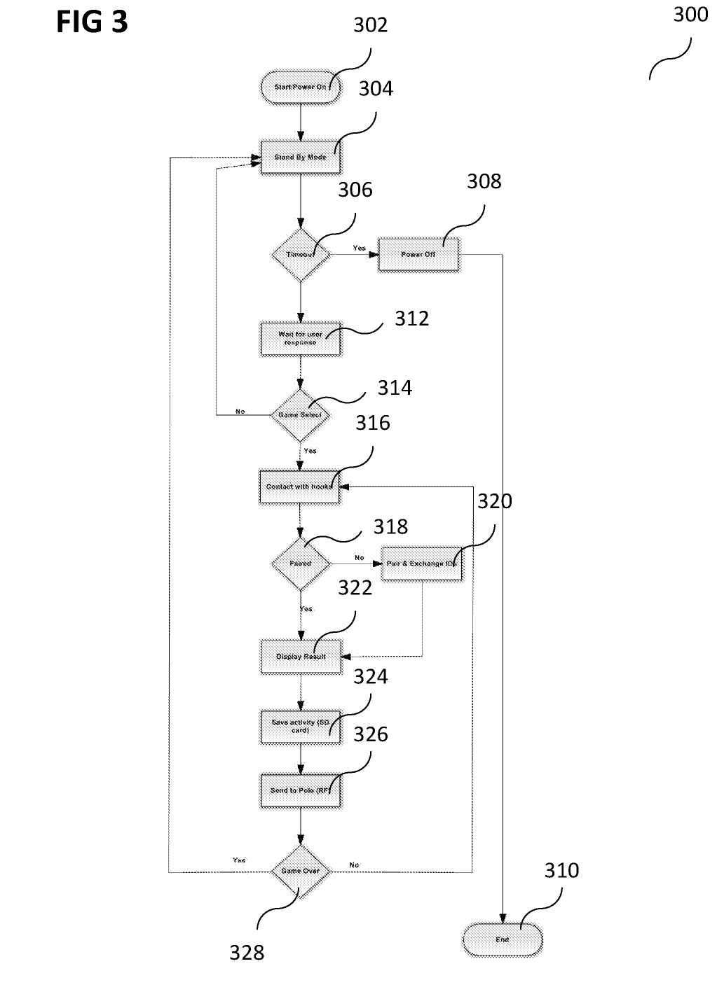

FIG. 3 shows an activity flow diagram 300 for the platform (in other words: for the device board; in other words: for the rehabilitation backboard device) according to various embodiments. In 302, for example upon switching power on, the method may start. In 304, the method may be in a standby mode. In 306, it may be determined whether there is a timeout. If there is a timeout, power may be switched off in 308, and the method may end in 310. If it is determined in 306 that there is no timeout, it may be waited for a user in 312. In 314, it may be determined whether a game is selected. If no game is selected, processing may proceed in the standby mode in 304. If it is determined in 314 that a game is selected, contact with the hooks may be provided in 316. In the gamified version, the hooks may light up in sequence and the patients may have to place the pole of the lighted up hooks. According to various embodiments, a more advanced level may be provided where the hooks light up randomly and the patients are supposed to place the pole of the lighted up hooks. In 318, it may be determined whether the platform and the portable device are paired. If they are not paired, processing to pair and exchange IDs (identifiers) may be carried out in 320, and processing may proceed in 322. If it is determined in 318 that the platform and the portable device are paired, processing may proceed in 322. In 322, the result may be displayed. In 324, information about an activity may be safe (for example on an SD card). In 326, information may be sent to the portable device (for example to the pole). In 3228, it may be determined whether the game is over. If game is over, processing may proceed in 304, otherwise, processing may proceed in 316.

For SHRUG Games, the device (for example the platform) may be operated by the single button, to select the game. The device may include a number of functional modes, which may be termed ‘games’. A most basic mode may replicate a standard rehabilitation operation, whereby the board identifies each set of hooks in turn using the LEDs, and the patient places the pole into the corresponding hook pair. This continues up the board, and when this is complete the operation begins again at the lowest hook pair. The second game mode is a ‘shuttle run’. In this, the device nominated the hook pairs as in the basic mode, but now the time allowed for the patient to place the pole in the hook pairs is gradually reduced, forcing the patient to gain speed through the exercise. The third and final game mode is ‘catch the lights’ where the board selects a hook pair at random, so the patient will not know which hook pair or level will be selected next.

The portable device (in other words: the pole interface; in other words the SHRUG pole interface) may monitor the patients approach to the board using the IMU sensor built in. The pole detects the horizontal angle, with the aim of the patient to keep the pole level at all times. However, if a patient does not achieve this, the pole measures this angle, which may be referred to as the ‘disparity in shoulder harmony’ (or DiSH). This angle of DiSH, which may correspond to the difference in height between the two ends of the pole, may indicate that one shoulder is not being worked in the same way as the other. The pole may give feedback on this angle of DiSH by illuminating one or more of the LEDs along its length. The greater the angle of DiSH, the more LEDs are illuminated. There may be two strips of LEDs in the pole interface as it is not possible to enforce the patient to hold the pole with a single strip of LEDs facing them, and so opposite strips of lights ensure that they can be seen no matter what rotation the pole is being held at.

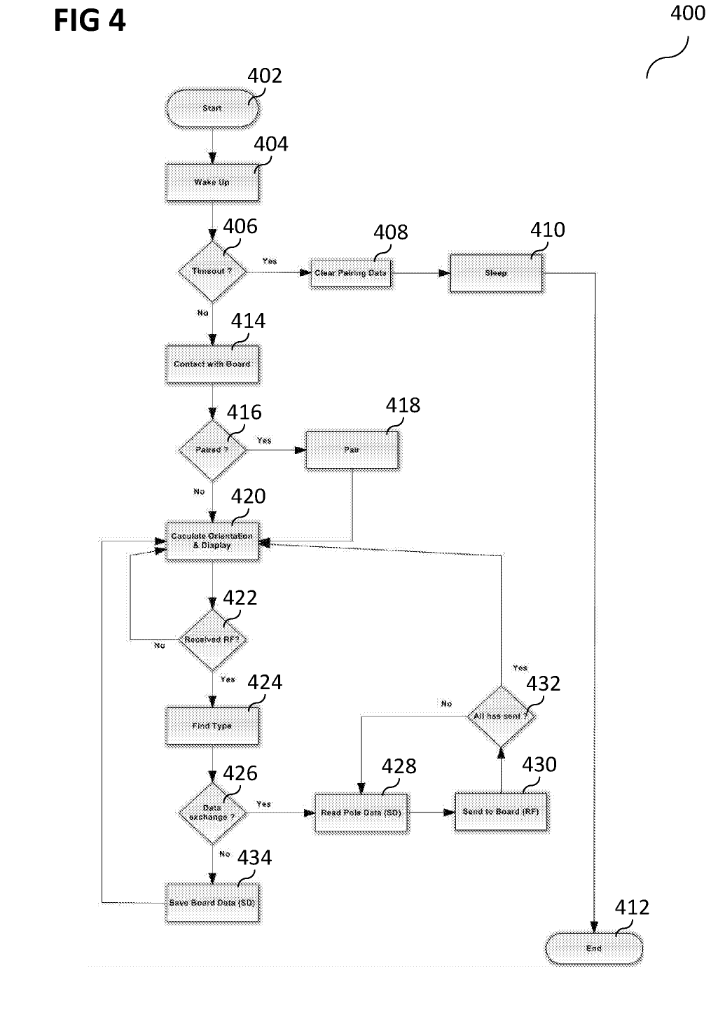

FIG. 4 shows an activity flow diagram 400 for the portable device (in other words: for the pole; in other words: for the pole interface) according to various embodiments. Processing may start in 402. In 404, the pole may wake up. In 406, it may be determined whether there is a timeout. If there is a timeout, pairing data may be cleared in 408, the pole may go into a sleep mode in 410, and processing may end in 410. If it is determined in 406 that there is no timeout, the pole may contact with board in 414. In this step, the pole may start to connect (in other words: pair) to the platform. In order to communicate data between the pole and the platform, pairing needs to be first through the wireless connection. In 416, it may be checked whether the pole is paired with the platform. If it is paired, it may be paired in 418. As described above, for the pole to be able to communicate data, it should be paired with the main platform, and if it is not paired, the pairing routine may start in 418. In 420, the orientation may be calculated and displayed. In 422, it may be determined whether radio data are received via RF (radio frequency). If no radio data are received, processing may proceed in 422. If radio data are received, the type of radio data may be determined (or found) in 424. In 426, it may be determined whether to perform data exchange. If data exchange is to be performed, the pole data may be read, for example from an SD memory card, in 428, and send to the platform (in other words: to the board), via RF in 430. In 432, it may be determined whether all data has been sent. If all data has been sent, processing may proceed in 420, otherwise, processing may proceed in 428. If it is determined in 426 that data exchange is not to be performed, board data may be save in 434, for example on the SD memory.

FIG. 5 shows an illustration 500 of the composite structure of the platform (in other words: of the backboard device) according to various embodiments. The platform may include a microprocessor 502, for example a 32-bit microprocessor (for example an Arduino Due), an RF transceiver 504 (which may communicate with the pole), a display 506 (for example an RGB (red-green-blue) LED (light emitting diode) array or e-ink (electronic ink), a micro SD card module 508 (for example for data logging), a real time clock 510, a supply unit 512 (for example a 9V battery and a power adapter in interface), an on/off button 514, a supply control unit 516, a sensor unit 518 (with switches at each hook), a game select/change button 520, and an initial pairing unit 522 including a voltage direction detector and controller 526 and contact switches or a conductive sticker 524.

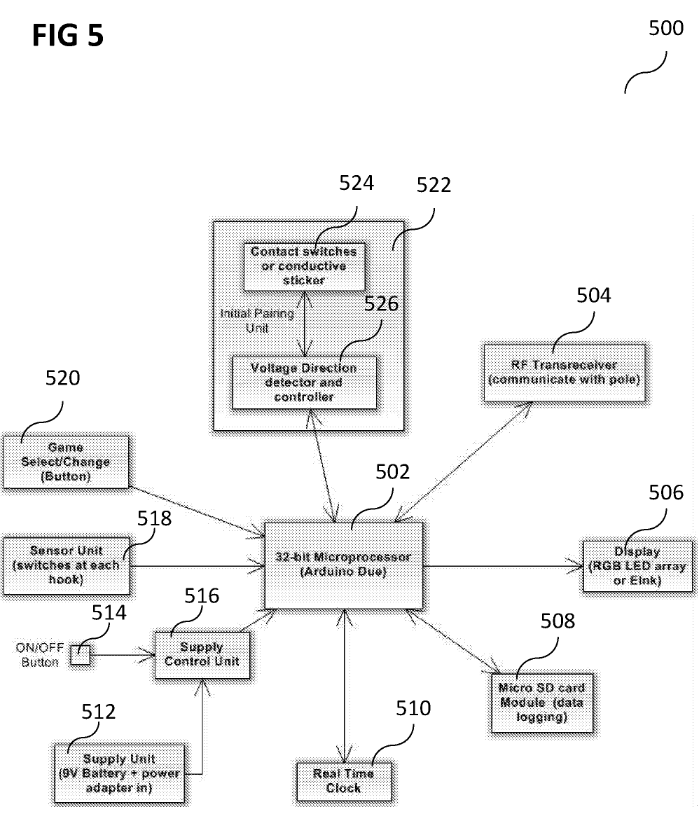

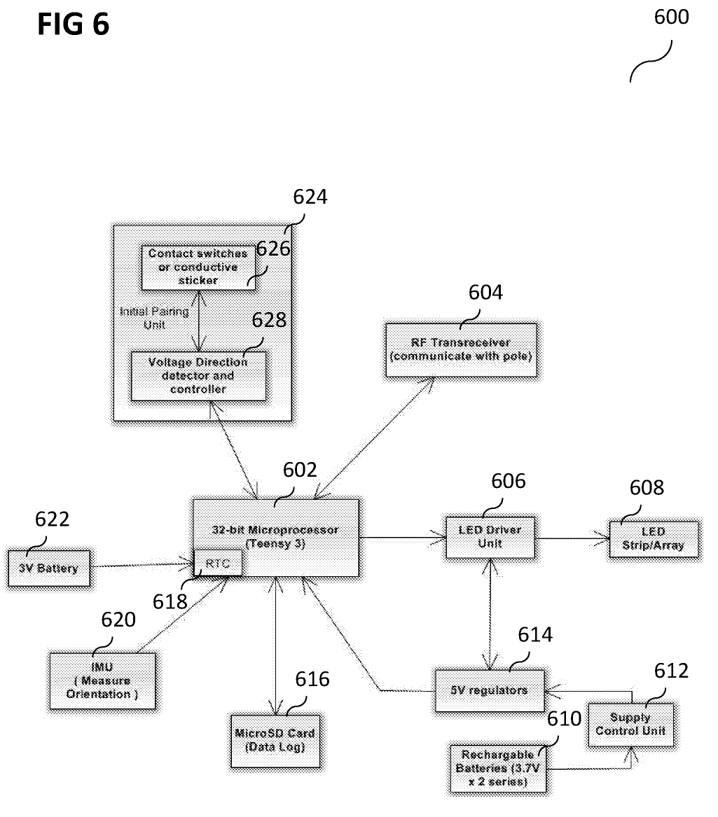

FIG. 6 shows an illustration 600 of the composite structure of the portable device (in other words: pole; in other words: of the pole interface) according to various embodiments. The portable device may include a microprocessor 602 (for example a 32-bit microprocessor (for example a Teensy 3)) with an RTC (real-time-clock) 618, an RF transceiver 604 (for communication between the pole and the platform), an LED driver unit 606, and LED strip (or LED array) 608, rechargeable batteries 610 (for example two 3.7 V batteries in series), a supply control unit 612, a 5 V regulator 614, a micro SD card 616 (for data logging), an IMU (inertial measurement unit) 620 (configured to measure the orientation of the pole), a 3 V battery 622, and an initial pairing unit 624 with a voltage direction detector and controller 628 and contact switches or a conductive sticker 626. It is to be noted that the battery 622 and the IMU 620 are generally connected to the microprocessor 602, and not in particular to the RTC 618.

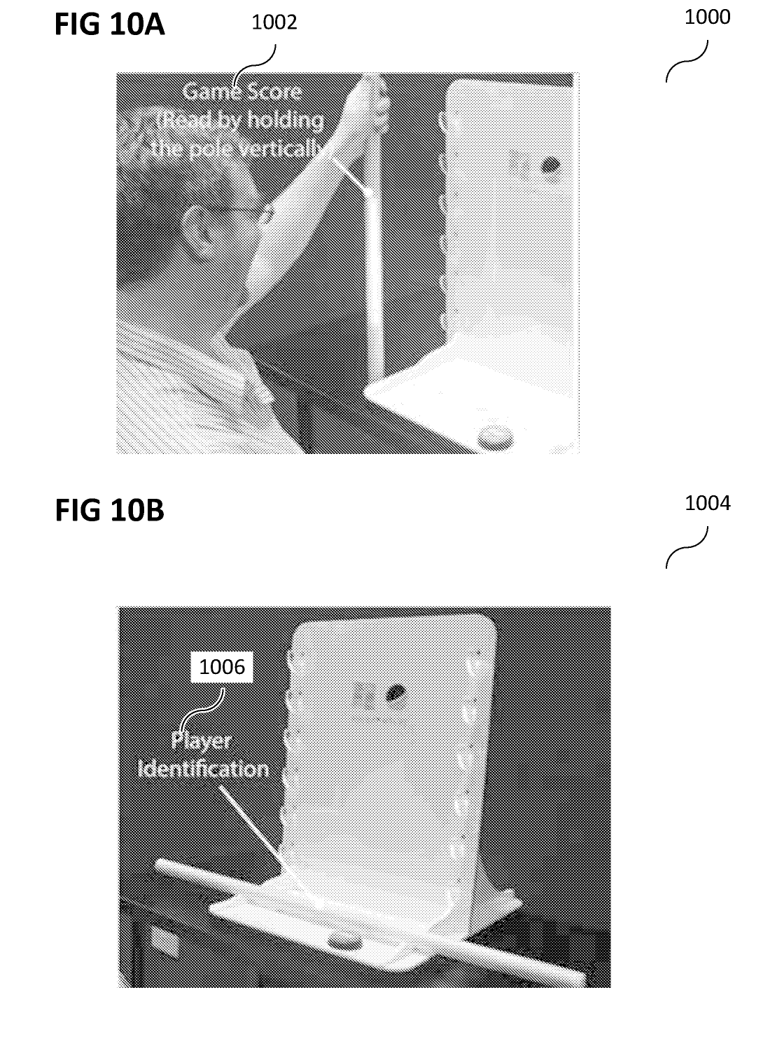

In total, the device (in other words: the platform) and the pole (in other words: the portable device) may score the patients performance along three factors: the time taken to complete the task of placing the pole into the hook pairs (scored on the device), whether the pole was placed into the hook pair simultaneously, activating both hooks at approximately the same time (scored on the device) and the aspect of the pole, being held horizontally on the approach to the device (within the 5 seconds preceding placement into the hook pair, scored on the pole interface). The score may be calculated as a percentage, and an average across all trials of the patient with the rehabilitation exercise. The score is aggregated by the pole itself. At any time, the patient may up-end the pole, turning it 90 degree to stand on one end (like will be described with reference to FIG. 10A below). This activates the score display, where the percentage score is displayed by the LEDs along the pole, in 5% increments per LED.

More data than this may be captured by both the device and the pole interface. More detailed data may be stored on the device itself. This data may be made available to medical professionals overseeing the patients rehabilitation.

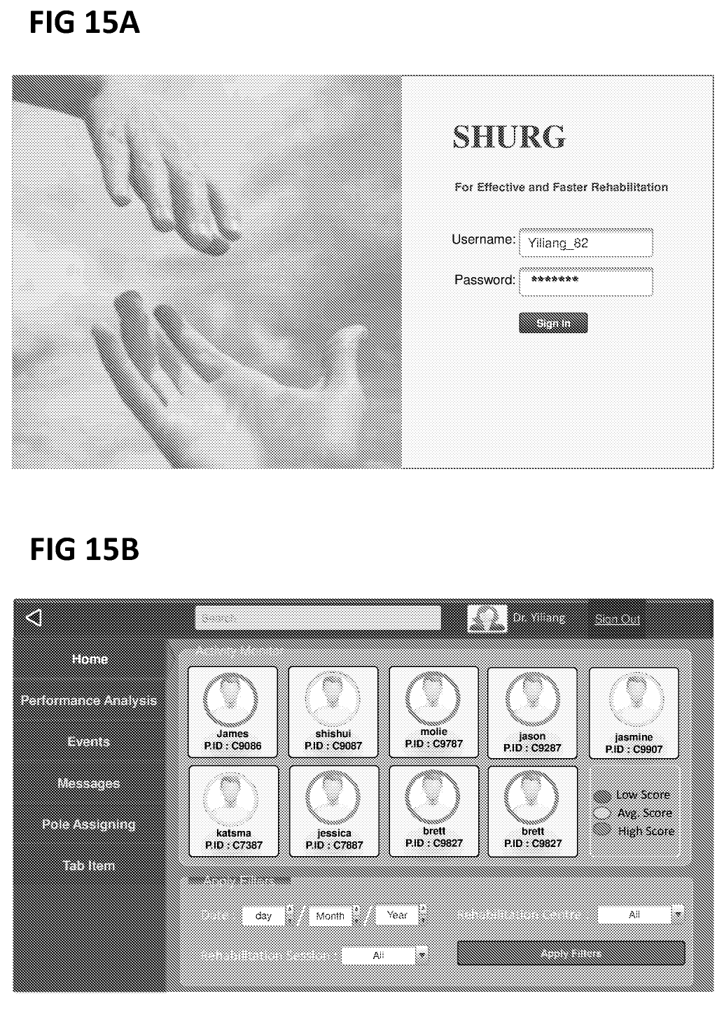

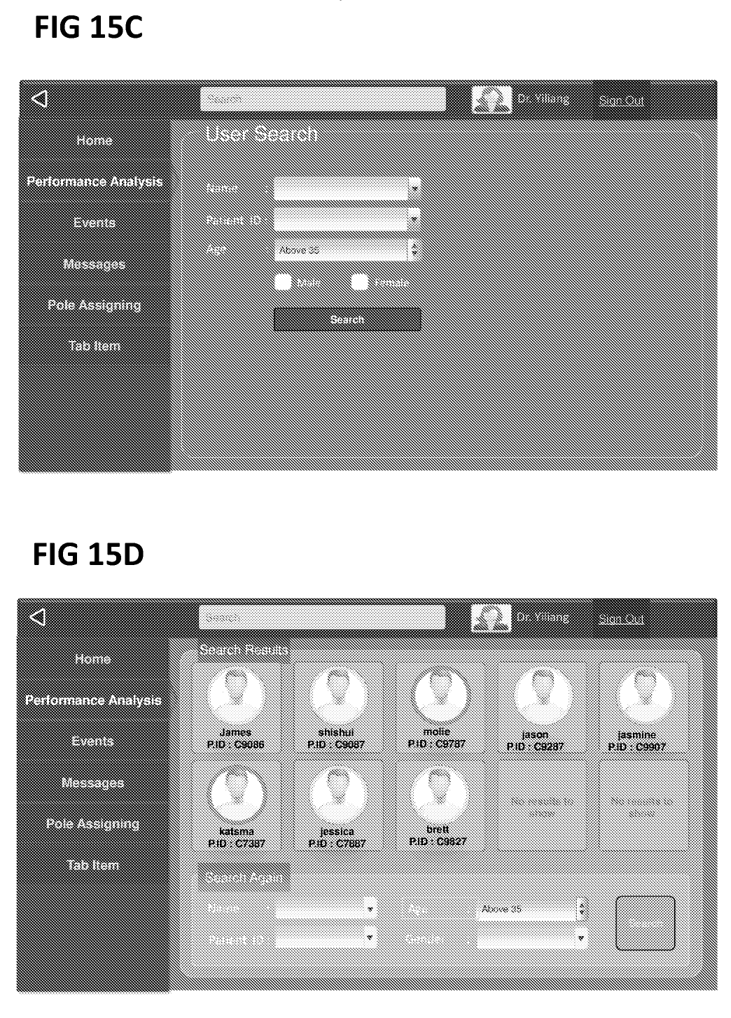

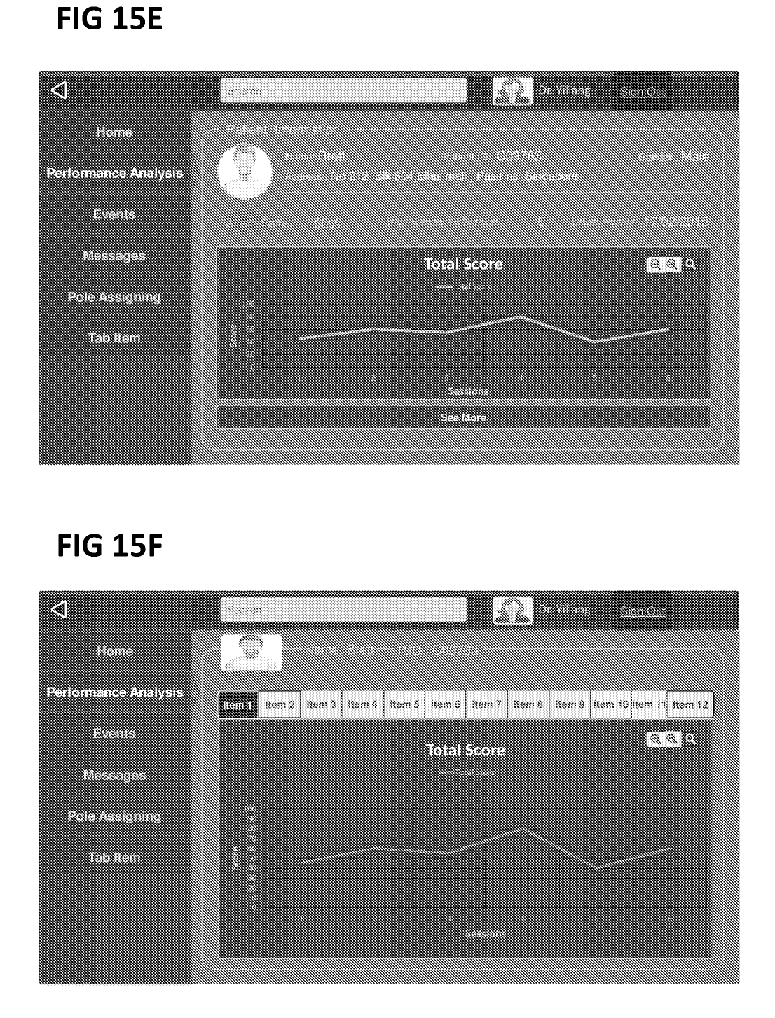

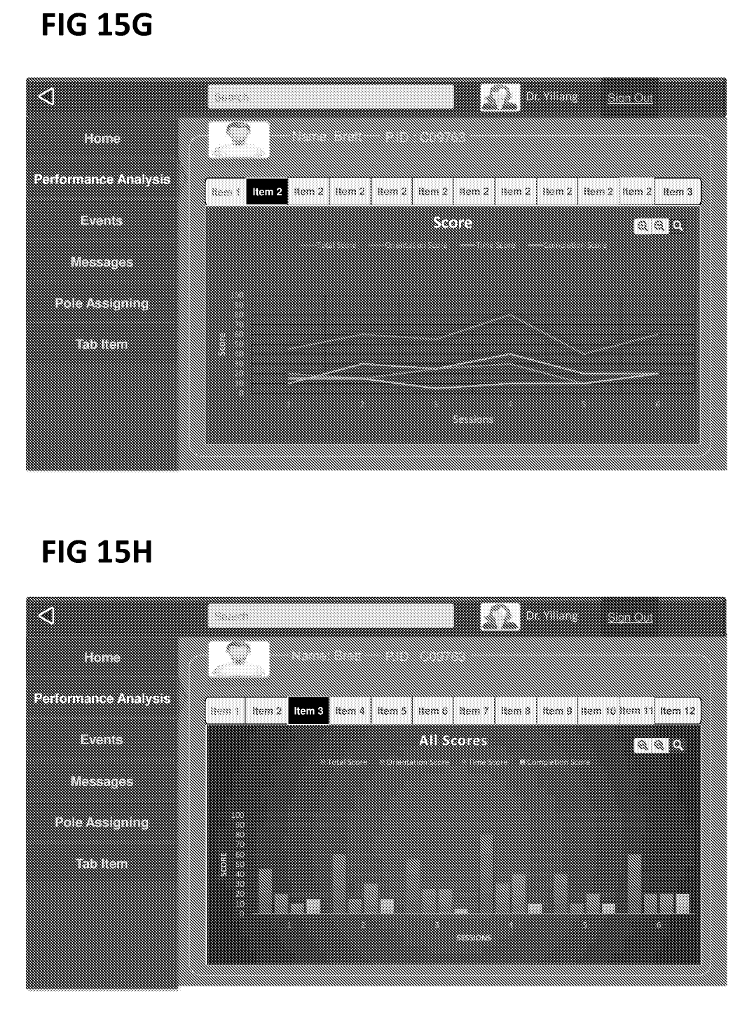

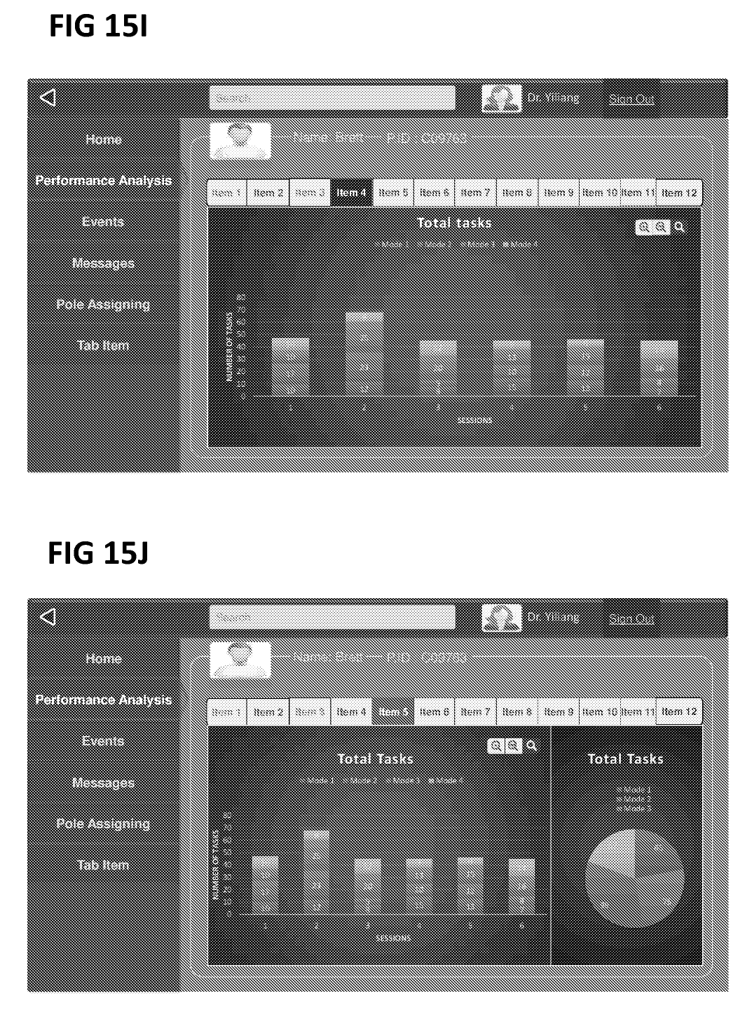

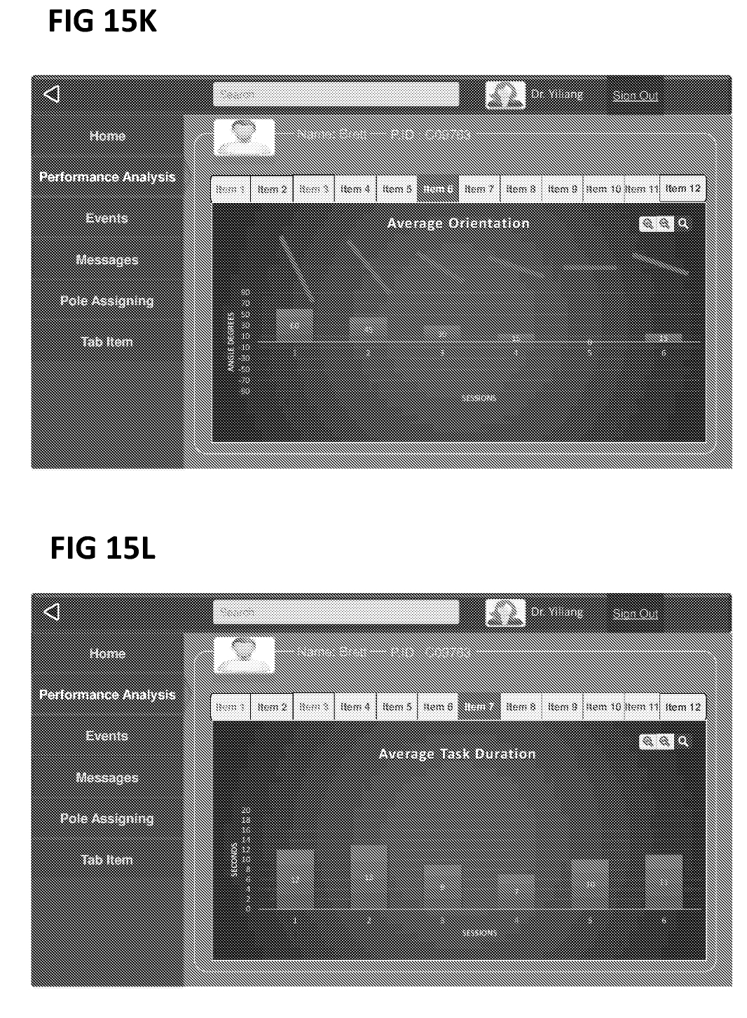

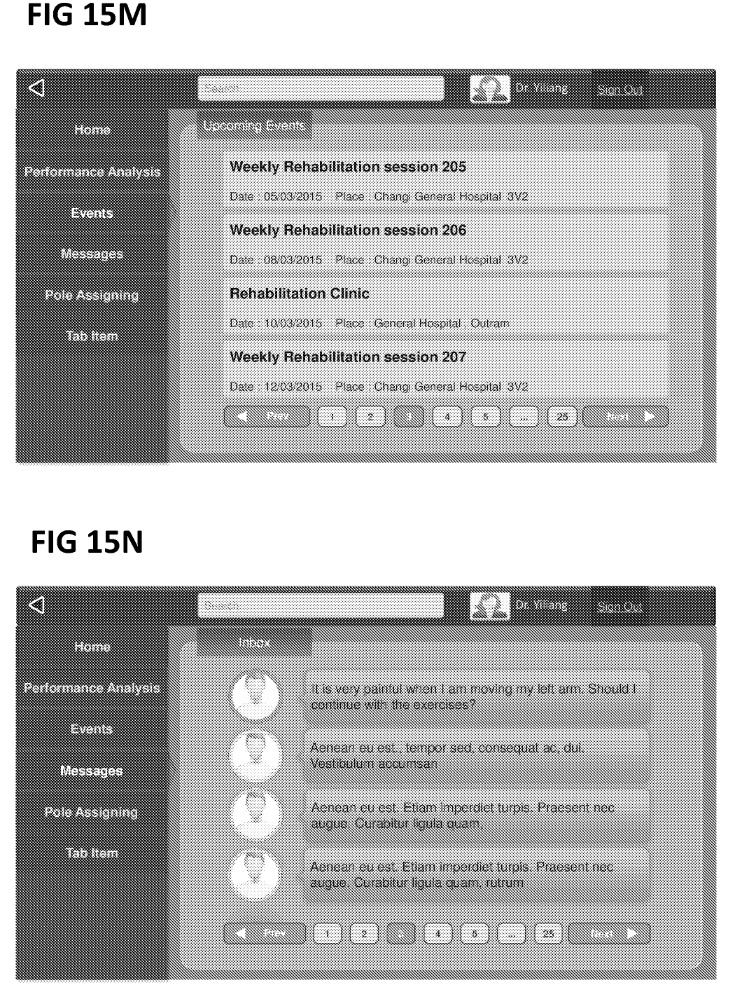

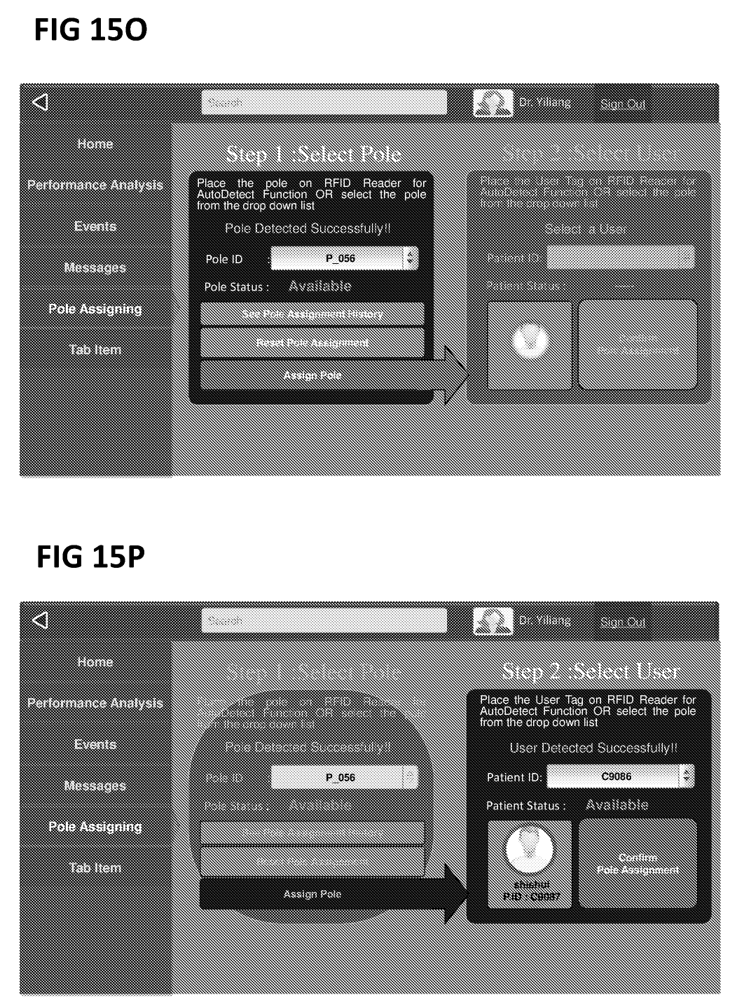

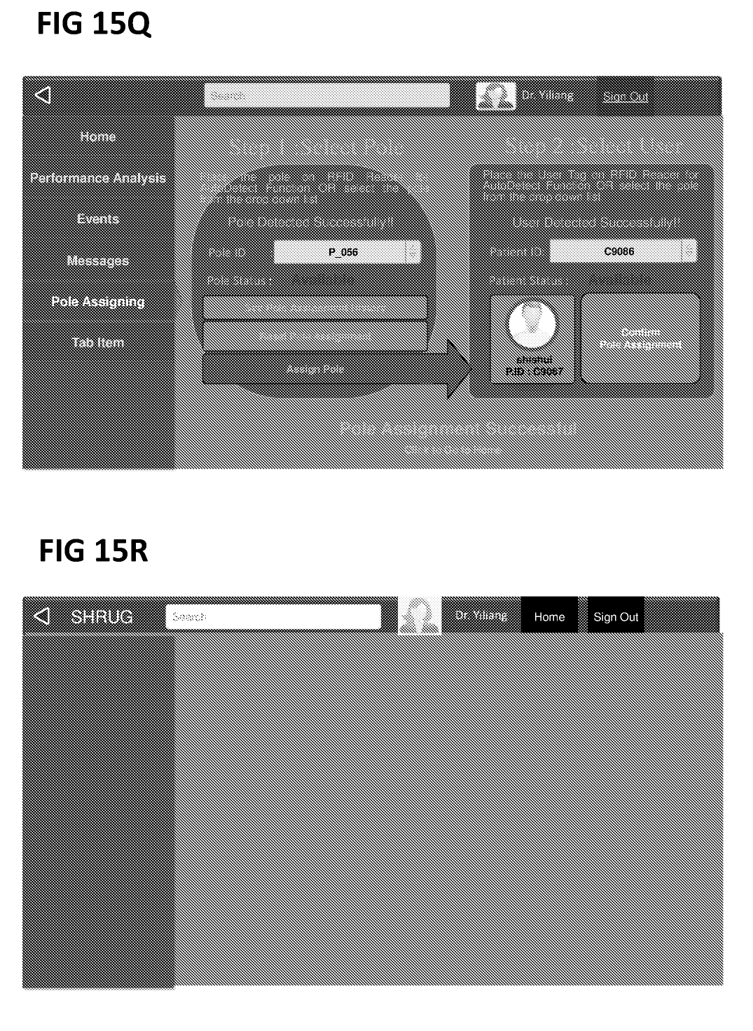

FIG. 7 shows an illustration 700 of the composite structure of the software provision (in other words: of a simulation unit) according to various embodiments. A computer 702 may include a processing unit 706 configured to process data. A micro SD card reader 704 may provide data to the processing unit 706. The processing unit 706 may output data (for example simulation results and a synthesis of actions) on a display 708. This may provide a visualization. The system may have a data visualization system for therapists to understand the summary of activities and performance of the patients. FIG. 15A to FIG. 15R show illustrations of screenshots of the system.

According to various embodiments, the SHRUG therapists platform may include two devices for the therapists. Firstly, the therapists receives a therapists' console which allows the therapists to place each user/patients' pole at the console to read and download their performance data. This will allow the therapists to read and download the data onto their consoles for later analysis and individual customizations of the rehabilitation program. Secondly, each of the therapists will receive a smart wearable wrist band that solely is dedicated for alerts. These devices will activate if a patient is having difficulties in executing their programs or even in emergencies depending on the context.

According to various embodiments, the rehabilitation board (in other words: the platform) and the pole (in other words: the portable device) of SHRUG are provided as responsive objects. For example, feedback elements such as LEDs and sensors are embedded within the object itself (for example in the hooks and/or in the pole) which lights up interactively to respond to the user. Thus, both objects use minimal user interfaces allowing the users to intuitively interact with the SHRUG system without much prior training. This allows the users to interact with the rehabilitation device as they were previously used to but with immediate feedback of their actions.

According to various embodiments, the rehabilitation board (in other words: the platform) may include sensors on the hooks (which may sense where the pole was placed by the patient), hooks that light up (which may indicate correct placement or the target placement by lighting up in different colors, and which may be used to indicate various features/stages of a rehabilitation process), a push button (which may be a single button on the platform, and which may allow the patients to select various features/games of a rehabilitation process), and an RFID Reader (which may be invisibly embedded in the platform, and which may allow the system to identify each patient at the beginning of a rehabilitation session).

According to various embodiments, the pole (in other words: the portable device) may include an orientation sensor (which may be configured to sense if the user is holding and moving the pole as required), lights (for example 40 LEDs embedded in the pole, which may light up in different colors to indicate wrong holding pattern; turning the pole horizontal may indicate additional scores of the rehabilitation process), and an RFID tag (which may be configured to allows the patient to identify himself to the system by simply placing the pole on the platform).

According to various embodiments, gaming elements may be provided. Existing rehabilitation systems in use are passive, repetitive and rely heavily on constant medical guidance. However, with the interactive SHRUG platform according to various embodiments, serious games (in other words: games that have another purpose that entertainment) may be used for the rehabilitation process for the patients. For example, four games with advancing difficulties may be provided as follows:
Game 1: The control state. This game is similar to existing systems where the users can follow their own pace with no feedback.
Game 2: With immediate feedback. This game allows the users to follow their own pace but with feedback from the lighted up hooks and pole.
Game 3: This game advances at a game controlled pace, with feedback and sequentially. That is, the patient has to place the pole on sequentially advancing positions on the platform. As the patient keeps up, the game increases the challenge by speeding up the process.
Game 4: This game is similar to game 3, but with random positioning.

The varying challenging nature of each game gives the opportunity for the patient to motivate himself or herself to get through the rehabilitation process. The patients can select the required game by pressing the push button on the platform. With the instant feedback and guidance from the responsive platform and the pole, the patient can continue to move through the rehabilitation process. The patients can view their score by holding the pole vertical that makes a portion of the pole light up corresponding to the score.

According to various embodiments, adaptive gaming difficulties may be provided. Like described for games 3 and 4 above, the games adapt to the patients performance. Such adaptations lets the patients stay motivated and engaged in the rehabilitation process. Following are some adaptive features of the SHRUG games according to various embodiments:
Game pace: Games pace up for when the patient performs well or slows down if the patient finds the movements difficult.
Performance difficulty: In game 4, the random targets become widely apart as the patient's performance improvements.
Overall performance: In addition to the in-game performances, the scores also take in to account, the continuous participation of a patient in his rehabilitation program. That is, if a patient misses any of the scheduled sessions, the score would decrease and motivate the patient to continuously take part in the program.

According to various embodiments, at any given time, the patients may hold the pole vertically to read the score.

According to various embodiments, personalized motivation may be provided. Each patient may possess their own pole to interact with the game. The personalization may be provided at 420 as shown in FIG. 4. For example, a gaming mode may be personalized to use only certain number of hooks depending on the ability of a particular patient. This may be something they own during the duration of their program. In contrast to the existing systems, this notion of owning the pole is targeted as a personal motivation factor to the patients.

According to various embodiments, the therapists may be equipped with a therapists console and/or therapists smart band. This console may allow the therapists to place the pole(s) on the console and download/review patients' performance. In addition, individual therapists may be provided with a smart wrist band that provides any just-in-time information such as critical alerts, for example.

According to various embodiments, performance data analysis and storage may be provided. In addition to the continuous analysis of the performance data, the SHRUG system may store all of the patients' individual performance data in a database. As such, therapists may have access to a performance history of the data which is not possible in existing passive systems. The data analysis and storage allows the following:
Alerts: The therapists may be notified immediately if the patients are performing wrong actions continuously.
Performance history: The therapists and doctors may go back to any point of time in the patient's rehabilitation history and review any of their performance.
Personalized programs: By reviewing performance history, the doctors may identify and personalize the rehabilitation program for the patients according to their performance.

Various embodiments may be used in the rehabilitation of patients who have suffered a stroke.

Various embodiments may be used for patients regaining torso mobility by requiring them to twist their torso and arms until the pole reaches a specific point in space, wherein the LEDs may be used to acknowledge that this goal has been achieved. It will be understood that further applications for this interface in a similar physiotherapy setting exist.

According to various embodiments, the pole interface may be used beyond rehabilitation, as a more general interface device, for example in a similar way to the Wii remote controller.

According to various embodiments, remote monitoring of the patient performance by the medical team may be provided using WiFi (at the patients home) or through a cellular mobile radio communication, for example a 3G connection, embedded into the platform.

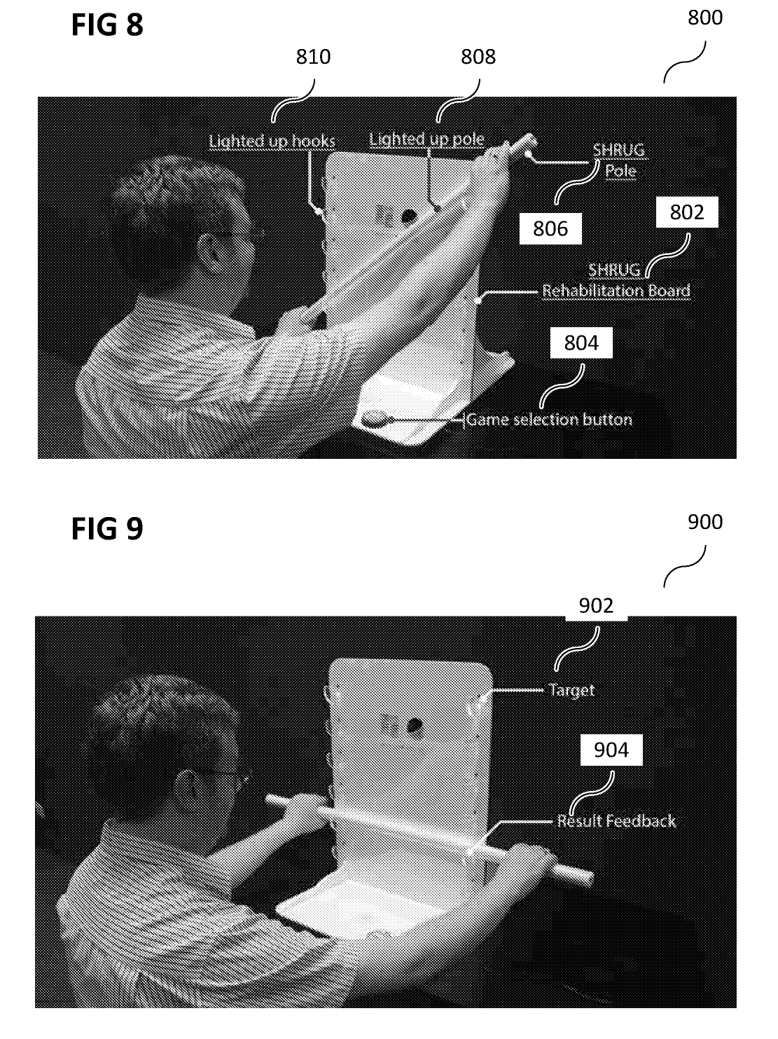

FIG. 8 shows an illustration 800 of SHRUG responsive objects according to various embodiments. The SHRUG rehabilitation board 802, the game selection button 804, the SHRUG pole 806, the lighted up pole 808, and the lighted up hooks 810 are shown.

FIG. 9 shows an illustration 900 of game feedback according to various embodiments. A target 902 and a result feedback 904 are shown.

FIG. 10A shows an illustration 1000 of reading the score on the personalized pole according to various embodiments. Like illustrated by 1004, the game score can be read by holding the pole vertically.

FIG. 10B shows an illustration 1004 of placing the pole on the platform for identification according to various embodiments. Like illustrated by 1006, the player may be identified, for example using RFID technology.

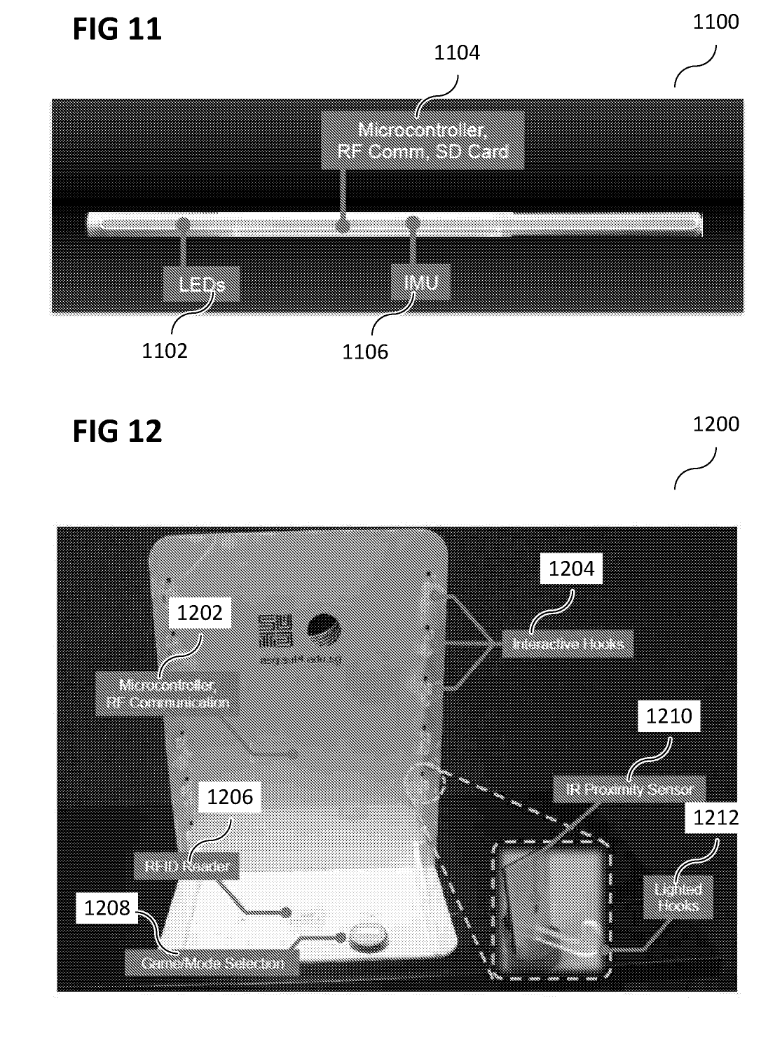

FIG. 11 shows an illustration 1100 of the SHRUG pole contents according to various embodiments. The SHRUG pole may include several hardware components which provide its functionalities. A microcontroller 1104, for example a Teensy 3.02 microcontroller, may be used as the main microcontroller on board. An orientation sensor 1106 (in other words: an IMU (inertial measurement unit); for example an ArduIMU3) may detects and keeps track of the orientation and movement data of the pole. A LEDs 1102, for example a strip of 40 RGB LEDs, may be spread throughout the pole in a single profile. This may provide the user with feed-back when the pole is not horizontal or indicate progress results when the pole is held vertically. An RFID (Radio Frequency Identification) tag embedded in the pole may give each pole a unique ID. Once the pole is placed on the platform, the system may recognize the patient. A micro SD memory card on the pole may record all the movements data of the patients. This data may be downloaded later by the therapists for analysis.

FIG. 12 shows an illustration 1200 of the SHRUG platform contents and features according to various embodiments. The SHRUG platform may use a microcontroller 1202, for example an Arduino Due as its main controller, which may also provide RF communication. An RFID reader 1206 on the platform may be used to identify the RFID tag of the pole and register the patient. Each hook 1204 of the platform may be embedded with a RGB LED (like shown in the enlarged portion 1212, which may make the hook light up in different colors. A proximity sensor 1210, for example an infrared (IR) proximity sensors, may be placed just behind the hook 1212 and may be used to detect the pole positioning on the platform. According to various embodiments, proximity detection may be performed with one or more IR proximity sensors embodied within the hook. 1212 A game selection button 1208 on the platform may allow the users to identify and select various games of the exercise program.

According to various embodiments, the platform may communicate with the pole using RF (radio frequency). At the initial stage of the game, this communication channel may be used to exchange patient identification information in order to pair the pole and the platform. During the exercise, the pole may record the orientations of itself and its position on the platform that is sensed by the IR sensors.

According to various embodiments, a universal, personalized pole may be provided. The pole may be an important component of the SHRUG exerciser. With SHRUG, according to various embodiments, a universal device may be provided that represents the patient throughout the exercise program. As such, the pole used in SHRUG according to various embodiments is designed in a way that it is universal. The pole may be used as the main device for the patient to interact with the SHRUG exercise: for identification, exercise, data storage, may be used as the main the therapists to obtain patient data and history, may provide immediate feedback to the patient on his performance and exercises, may provide for simply placing the pole at the platform identifies the patient for the exercises, and may provide for simply placing the pole at the therapists' station downloads the data. Furthermore, the pole used in SHRUG according to various embodiments is designed in a way that it personalized: The pole represents the patient, may be used to store his/her history and exercise data, and may be used as a personalized motivator to the patient by displaying their progress.

According to various embodiments, a simple and intuitive gesture may be used for obtaining performance data. Holding the SHRUG pole vertically may immediately display the patient's progress/score in the overall exercise program. According to various embodiments, an intuitive gesture may be provided to view the progress of the patient. The pole may be used without any prior knowledge or any pre-required understanding of the system. According to various embodiments, a scoring system may be provided which adapts to the display capabilities of the SHRUG pole where the score is displayed as a percentage of the length of the pole without exceeding the maximum or minimum length of the pole. According to various embodiments, a scoring system may be provided which is presented to the patient visually as a “progress-bar-like-display” instead of adhering to standard numerical values. This may allow the patient to immediately understand his progress within the program.

According to various embodiments, an overall interactive exercise monitoring system for the therapists may be provided. A wearable minimalistic display interface that alerts the therapists only in case of emergencies or if a patient repeats a mistake may be provided. The therapists may have the freedom to use the system as deemed fit, by the flick of a button to activate all interactivity and other feature of the SHRUG system.

According to various embodiments, interacting with SHRUG may be as follows: As the pole is placed on the platform, all hooks on the platform light up and blink to indicate successful identification and pairing. Next, the patient can select the required game and continue with the program.

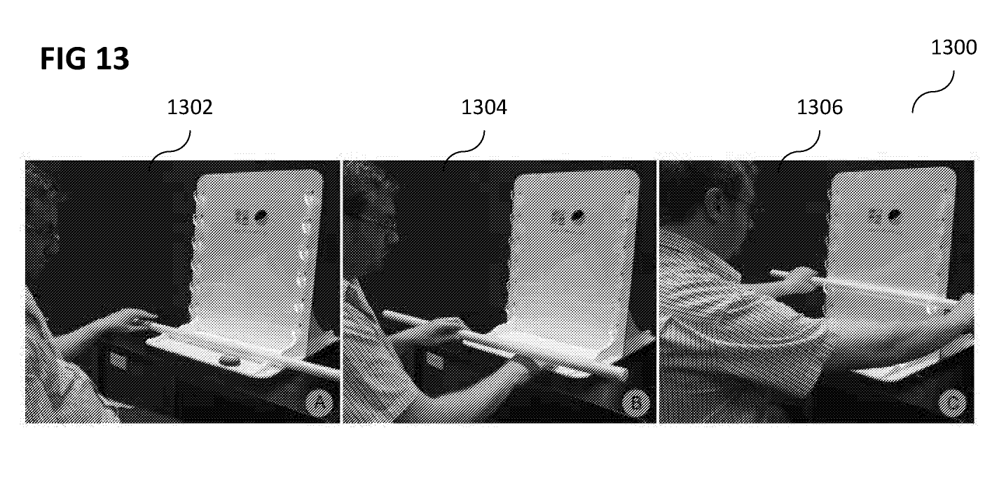

FIG. 13 shows an illustration 1300 of an interaction scenario according to various embodiments. Like illustrated in 1302, the pole may be placed on the platform for identification. Like illustrated in 1304, the game may be selected using the selection button on the platform. Like illustrated in 1306, the pole may be placed on the platform hooks as required by the game.

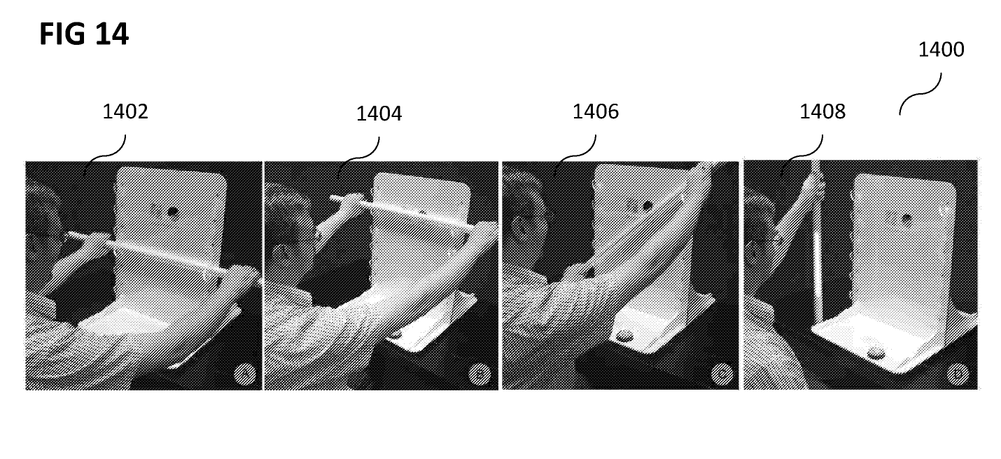

As the patients interact with the SHRUG, various states may be represented visually through the lighted up hooks on the platform and the pole, like illustrated in FIG. 14. For example, green hooks may indicate the correct placement of the pole on the platform, like illustrated in 1402. For example, red hooks may indicate an incorrect placement of the pole on the platform, like illustrated in 1404. For example, blue hooks may indicate the target hooks, like illustrated in 1406. According to various embodiments, the pole may light up if not held horizontally, like illustrated in 1408. Holding the pole vertical may display the progress/game score of the patient.

Once the exercise is completed, the pole may be returned to the therapists who may retrieve the data from the SD card on the pole. This may allow therapists to have access to the performance history of the patients. By reviewing performance history, the therapists may identify and personalize the rehabilitation program for the patients according to their performance.

According to various embodiments, four main modes as follows may be provided. There may be three main modes (Feedback only, Game 1, Game 2), and a forth mode may be to use the system without any feedback or gaming. This for the mode to serve as the control (benchmark) for the other modes. The modes may be provided to evaluate the effects of interactivity and gamification of rehabilitation exercises using SHRUG prototype.

In a first mode, the platform and the pole do not provide any form of feedback to the patient. The physical form of the SHRUG may be similar to the specifications of existing passive exercisers; this mode may be considered the control state. This is because in this mode, SHRUG operates very similar to the existing passive rehabilitation exercisers.

In a second mode, patients may follow their own pace with the exercise but are provided with immediate interactive feedback through the platform (lighted up hooks) and the pole. The effects of interactivity may be evaluated by comparing the evaluations of Mode 1 and Mode 2.

In a third mode, a set of hooks lights up and sequentially advancing positions on the platform. The patient has to follow these moving lights with the pole. As the patient keeps up, the game increases the challenge by speeding up the process. The effects of gamification are evaluated in this mode by comparing the evaluations of Mode 2 and Mode 3 (as the only difference between Mode 2 and Mode 3 is the gamification). In this mode, the difficulty may be furthered by having the hooks light up at random locations.

In addition to the in-game performances, the pole may record the task completion time, and the accuracy of the process (holding the pole horizontal being the desired position). The evaluation intends to target various factors such as the patients' motivation, speed of recovery, experience of the therapists etc. These may be evaluated through interviews and discussions.

In addition, the logged data may be correlated with the standard evaluation done by the therapists that includes evaluating performing certain tasks such as completing activities of daily living.

The system according to various embodiments may be safe for using the system without any exposure to danger.

The system according to various embodiments may be easy to use; it may be used without any complex training. The pole may be reinforced with several layers of (for example thick) materials.

The system according to various embodiments may provide cleaning-ability to withstand general cleaning procedures of the hospital.

According to various embodiments, a mechanism (for example an LED brightness control interface) to control the brightness of the lights on the platform and the pole may be provided.

According to various embodiments, SHRUG, an interactive shoulder rehabilitation platform, may be provided.

According to various embodiments, a therapist's interface may be provided. According to various embodiments, SHRUG system may provide a therapists' platform that has two main components. Firstly, a therapists' console may be provided which allows the therapists to place each patients' pole at the console to read and download the performance data. The data visualization interface may allow the therapists to conduct analysis and individual customizations of the rehabilitation program. Secondly, a smart wristband may be provided to provide just-in-time alerts. These wearables may activate if a patient is making too many errors while executing their prescribed exercises or even in emergencies depending on the context.

According to various embodiments, different modes (for example interactive, passive and gamified) may be provided. For example, in the gamified version, the hooks may light up in sequence and the patients would have to place the pole of the lighted up hooks.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A system comprising:
a platform comprising a plurality of engaging members;
a portable device configured to engage with the platform using at least one engaging member of the plurality of engaging members; and
a feedback member configured to provide information indicating whether the portable device is engaged with the platform.

2. The system of claim 1,
wherein the platform comprises an indication member configured to indicate a target location, wherein the indication member comprises a light source.

3. The system of claim 2,
wherein the feedback member is configured to provide information indicating whether the portable device is engaged with the platform at the target location.

4-5. (canceled)

6. The system of claim 1,
wherein a plurality of indication members is provided, one indication member in proximity to each engaging member.

7. The system of claim 1,
wherein the portable device comprises a pole.

8. The system of claim 1,
wherein the portable device comprises a plurality of light sources.

9. The system of claim 8,
wherein the light sources comprise light emitting diodes.

10. The system of claim 1,
wherein the portable device comprises an orientation sensor and wherein the orientation sensor comprises at least one of an accelerometer, a magnetometer, a gyroscope, or an inertial measurement unit.

11. (canceled)

12. The system of claim 10, wherein the orientation sensor comprises the accelerometer, wherein the system further comprises:
a velocity determination circuit configured to determine a velocity based on an output of the accelerometer.

13-15. (canceled)

16. The system of claim 10,
wherein the orientation sensor comprises the inertial measurement unit and
wherein the inertial measurement unit comprises at least one of a 3 axis accelerometer, a 3 axis gyro and a 3 axis magnetometer.

17. The system of claim 1,
wherein the portable device comprises an orientation indication member and
wherein the orientation indication member is configured to indicate whether the portable device is in a horizontal orientation.

18. (canceled)

19. The system of claim 17,
wherein the portable device comprises a plurality of light sources; and
wherein the orientation indication member comprises the plurality of light sources.

20. The system of claim 1,
wherein each engaging member of the at least one engaging member comprises at least one hook or a pair of hooks provided at least substantially parallel near outer portions of the platform,
wherein the platform comprises an indication member configured to indicate a target location, and
wherein the indication member is provided in the at least one hook or the pair of hooks.

21-22. (canceled)

23. The system of claim 1,
wherein the feedback member is provided at the platform.

24. The system of claim 1,
wherein the feedback member is provided at the portable device.

25. The system of claim 1,
wherein the portable device comprises a success indication member configured to indicate a success rate of engaging the feedback member with the platform.

26. The system of claim 1, further comprising:
a detection member configured to determine whether the portable device is engaged with the platform,
wherein the detection member comprises at least one of a switch or an infrared proximity sensor.

27-28. (canceled)

29. The system of claim 1, further comprising:
a therapist console configured to receive data indicating a performance of a user of the system.

30. The system of claim 1, further comprising:
an alert device configured to provide an alert signal to a supervisor of a user of the system.

31. The system of claim 1,
wherein the platform comprises a radio frequency identification (RFID) tag,
wherein the radio frequency identification (RFID) tag is configured to at least one of identify a user of the system or identify itself to the platform.

32. (canceled)
